(19) United States
(12) Patent Application Publication
(10) Pub. No.: US 2012/0159111 A1
(43) Pub. Date: Jun. 21, 2012

(54) METHOD FOR MEMORY MANAGEMENT

(75) Inventors: Ik-Soon KIM, Daejeon (KR); Chae Deok LIM, Daejeon (KR)

(73) Assignee: Electronics and Telecommunications Research Institute, Daejeon (KR)

(21) Appl. No.: 13/331,958

(22) Filed: Dec. 20, 2011

(30) Foreign Application Priority Data
Dec. 20, 2010 (KR) 10-2010-0131035

(51) Int. Cl. G06F 12/02

(52) U.S. Cl. 711/170; 711/E12.002

(57) ABSTRACT

Exemplary embodiments of the present invention can reduce physical memory usage of programs executed in an operating system by immediately releasing an allocated memory region at the time of a request of unloading the memory region if it is determined that the memory region which is allocated by programs executed in the operating system becomes unnecessary. A method for memory management includes making a request of unloading a memory region from programs; reclaiming a physical memory region allocated to the programs; and maintaining a record of the memory region that the programs intend to use.

### CROSS-REFERENCES TO RELATED APPLICATIONS

The present application claims priority under 35 U.S.C 119(a) to Korean Application No. 10-2010-0131035, filed on Dec. 20, 2010, in the Korean Intellectual Property Office, which is incorporated herein by reference in its entirety set forth in full.

### BACKGROUND

Exemplary embodiments of the present invention relate to a method for memory management, and more particularly, to a method for memory management capable of reducing memory usage used for programs in an operating system or a middleware platform.

Memories used for programs executed in an operating system or a middleware platform are a very important resource in an operator and have a large effect on production costs and an operation speed.

In particular, the memory has a large effect on the production cost and the operation speed, or the like, of the most widely used embedded devices and the importance thereof has been further increased.

The existing operating system uses a lazy memory loading method that is a kind of demand paging.

The demand paging method uses a method for recording only a fact that specific programs intend to use predetermined memory regions without immediately allocating physical memory areas when the specific programs request memory uses to an operating system, and allocating a physical memory later when the programs actually use the memory region.

The allocated and used memory is automatically reclaimed again by the operating system only in special cases and most of the memory blocks move to a swap region that is located in a separate storage device.

Even though a memory region is not used by the running programs, the memory region can be occupied by the programs and therefore, the memory usage can unnecessarily increase when the swap region or the physical memory is occupied by the unused memory region of the running programs.

The unnecessarily occupied memory can more seriously increase in an operator without a swap region or with server programs running for a long period of time.

The above technology configuration is background art for helping understand the present invention but does not mean the related and well-known art pertains to the present invention.

### SUMMARY

An object of the present invention is to provide a method for memory management providing an immediate memory unloading mechanism so as to reduce memory usage of programs executed in an operating system or a middleware platform.

An embodiment of the present invention relates to a method for memory management, including: making, by programs, a request of unloading a memory region; reclaiming a physical memory region allocated to the programs; and maintaining a record of memory regions that the programs intend to use.

In one embodiment, the method for memory management may further include allocating a physical memory when the program again uses a memory region.

Another embodiment of the present invention relates to a method for memory management, including: requesting, by programs, memory use; recording the programs intend to use the memory region; allocating a physical memory when the programs use the memory region; making, by the programs, a request of unloading the memory; returning the physical memory allocated to the programs; and maintaining a record of the programs intend to use the memory region.

In one embodiment, the method for memory management may further include returning to the step of allocating a physical memory when the program again uses the memory region.

### BRIEF DESCRIPTION OF THE DRAWINGS

The above and other aspects, features and other advantages will be more clearly understood from the following detailed description taken in conjunction with the accompanying drawings, in which:

FIG. 1 is a diagram for describing a configuration of an operating system having an immediately releasing mechanism in accordance with an embodiment of the present invention; and

FIG. 2 is a diagram for describing the method for memory management in accordance with an embodiment of the present invention.

### DESCRIPTION OF SPECIFIC EMBODIMENTS

Hereinafter, embodiments of the present invention will be described with reference to accompanying drawings. However, the embodiments are for illustrative purposes only and are not intended to limit the scope of the invention.

In describing the embodiment, a thickness of lines illustrated in the drawings, a size of components, etc., may be exaggeratedly illustrated for clearness and convenience of explanation. In addition, terms described below are defined in consideration of functions in the present invention, which may be changed according to the intention or practice of a user or an operator. Therefore, these terms will be defined based on contents throughout the specification.

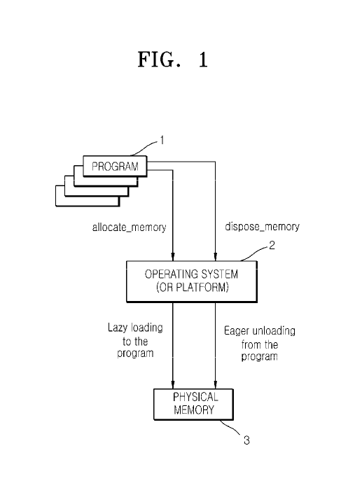

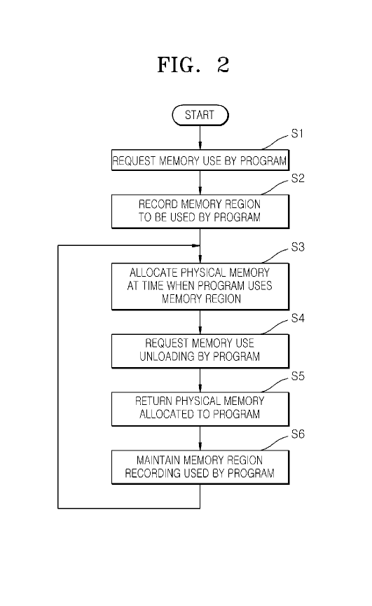

FIG. 1 is a diagram for describing a configuration of an operating system having an immediate releasing mechanism in accordance with an embodiment of the present invention and FIG. 2 is a diagram for describing a method for memory management in accordance with an embodiment of the present invention.

Referring to FIGS. 1 and 2, an embodiment of the present invention is configured to a physical memory 3, an operating system or a platform 2, and programs 1 executed on an operating system.

The operating system 2 provides an immediate memory unloading mechanism capable of immediately returning a physical memory 3 to a system when making a request of unloading the memory region to which the program 1 is allocated.

The allocation and deallocation process of the operating system 2 and the physical memory 3 will be described below.

First, the operating system 2 records that the program 1 will use the memory region (S2) when a specific program 1 requests a memory use (S1).

Thereafter, a lazy loading method of delaying the memory allocation is used until the requested memory region is actually used and allocating a physical memory at the time when the memory region is actually used (S3).

Next, if memory unloading is requested by determining that the memory region used by the program 1 is unnecessary (S4), the operating system 2 returns the physical memory 3 corresponding to the memory region allocated to the program 1 from the program 1 immediately after the operating system 2 receives the memory unloading requirements (S5).

The operating system 2 may use the returned memory region by allocating the returned memory region to other programs, if necessary.

In this case, the operating system 2 maintains a record of the memory region previously requested by the program 1(S6).

Further, when the program 1 again uses the memory region, the program 1 returns to a process of allocating the physical memory (S3).

Further, the lazy loading method of allocating the physical memory 3 is used herein.

As a result, when the process of immediately returning the physical memory 3 and then allocating the memory is performed, program 1 looks like it is continuously occupying the specific memory region in appearance, but the related physical memory region is actually returned and then, allocated again and the contents of the corresponding memory region may be filled with a garbage data value.

In summary, the embodiments of the present invention can reduce the memory usage of programs executed in the operating system by immediately releasing the allocated memory region at the time of the request of unloading the memory region if it is determined that the memory region to which the programs executed in the operating system are allocated is unnecessary.

In addition, the embodiments of the present invention can remarkably reduce the amount of used memory without particularly affecting the program execution speed as compared with the related art, when being applied to the existing operator.

In addition, the embodiments of the present invention can reduce the amount of physical memory required for the existing operator or execute more programs while maintaining the amount of physical memory.

As set forth above, the exemplary embodiments of the present invention can reduce the memory usage of programs executed in the operating system by immediately unloading the allocated memory region at the time of the request of unloading the memory region if it is determined that the memory region to which the programs executed in the operating system are allocated is unnecessary.

In addition, the exemplary embodiment of the present invention can remarkably reduce the amount of used memory while maintaining the processing speed, without particularly affecting the program execution speed as compared with the related art, when being applied to the operator.

In addition, the exemplary embodiments of the present invention can reduce the amount of physical memory required for the operator and execute more programs while maintaining the amount of physical memory.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A method for memory management of an operating system, comprising:
making, by programs, a request of unloading a memory region;
reclaiming a physical memory region allocated to the programs; and
maintaining a record of the memory regions that the programs intend to use.

2. The method of claim 1, further comprising allocating a physical memory when the program uses a memory region again.

3. A method for memory management of an operating system, comprising:
requesting, by programs, memory use;
recording a memory region that the programs intend to use;
allocating a physical memory region when the programs use the memory region;
making, by the programs, a request of unloading the memory region;
reclaiming the physical memory region allocated to the programs; and
maintaining a record of the memory region that the programs intend to use.

4. The method of claim 3, further comprising returning to the step of allocating a physical memory when the program again uses the memory region.
